(19) United States
(12) Patent Application Publication
(10) Pub. No.: US 2026/0180294 A1
(43) Pub. Date: Jun. 25, 2026

(54) TUBULAR MEMBER AND WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Jisung KIM, Yokkaichi-shi (JP); Naoya HAMAMOTO, Yokkaichi-shi (JP); Takeshi SHIMIZU, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 18/835,541

(22) PCT Filed: Jan. 17, 2023
(86) PCT No.: PCT/JP2023/001069

§ 371 Date: Aug. 2, 2024

(30) Foreign Application Priority Data
Feb. 3, 2022 (JP) 2022-015443

(51) Int. Cl. H02G 3/04; B62D 21/02

(52) U.S. Cl. CPC H02G 3/0406; H02G 3/0418; H02G 3/0468; H02G 3/0481

(57) ABSTRACT

A tubular member that includes a bellows portion that is tubular and includes a bellows structure in which a first peak and a first valley are disposed side by side along an axial direction of the tubular member; and a rigid portion that is tubular and has a higher bending rigidity than the bellows portion, wherein: the rigid portion includes a second peak and a second valley, which are disposed side by side along the axial direction of the tubular member, a channel formed by the second peak and the second valley, and a reinforcement formed so as to bury the channel at one part in a circumferential direction of the rigid portion, and the reinforcement protrudes outward in a radial direction of the tubular member beyond an outer circumferential surface of the second peak and extends along an axial direction of the tubular member.

### BACKGROUND

The present disclosure relates to a tubular member and a wire harness.

Wire harnesses used in vehicles, such as hybrid cars and electric cars, conventionally include electric wires that electrically connect electric devices, such as a high-voltage battery and an inverter. In a wire harness, the outer periphery of the electric wires is covered with a tubular external member to protect the electric wires. As this type of external member, a tubular member that is made of resin and includes a bellows portion, which has low bending rigidity, and a straight tube portion, which has high bending rigidity, has been proposed (for example, see JP 2013-243900A).

### SUMMARY

However, with the conventional external member described above, if the length and/or position of a straight pipe portion changes for reasons such as a change in the layout of the wire harness, the molds used to fabricate the external member will need to be remade. This results in the problem that wire harnesses are not easy to manufacture.

An exemplary aspect of the disclosure provides a tubular member and a wire harness that are easier to manufacture.

A tubular member according to an aspect of the present disclosure is a a tubular member that is made of resin, the tubular member including: a bellows portion that is tubular and includes a bellows structure in which a first peak and a first valley are disposed side by side along an axial direction of the tubular member; and a rigid portion that is tubular and has a higher bending rigidity than the bellows portion, wherein: the rigid portion includes a second peak and a second valley, which are disposed side by side along the axial direction of the tubular member, a channel formed by the second peak and the second valley, and a reinforcement formed so as to bury the channel at one part in a circumferential direction of the rigid portion, and the reinforcement protrudes outward in a radial direction of the tubular member beyond an outer circumferential surface of the second peak and extends along an axial direction of the tubular member.

A wire harness according to an aspect of the present disclosure includes the tubular member described above and the electric wire that is passed through the tubular member.

The tubular member and the wire harness according to aspects of the present disclosure are easier to manufacture.

### BRIEF DESCRIPTION OF THE DRAWINGS

FIG. 1 is a schematic diagram depicting a wire harness according to an embodiment of the present disclosure.

FIG. 2 is a schematic side view depicting a wire harness according to the embodiment.

FIG. 3 is a schematic cross-sectional view (a cross section along a line 3-3 in FIG. 2) of the wire harness according to the embodiment.

FIG. 4 is a schematic cross-sectional view (a cross section along a line 4-4 in FIG. 2) of the wire harness according to the embodiment.

FIG. 5 is a schematic perspective view of the wire harness according to the embodiment.

FIG. 6 is a schematic cross-sectional view (a cross section along a line 6-6 in FIG. 4) of the wire harness according to the embodiment.

FIG. 7 is a schematic cross-sectional view (a cross section along a line 7-7 in FIG. 4) of the wire harness according to the embodiment.

FIG. 8 is a schematic side view depicting a method of manufacturing the wire harness according to the embodiment.

FIG. 9 is a schematic cross-sectional view depicting a method of manufacturing the wire harness according to the embodiment.

FIG. 10 is a schematic cross-sectional view depicting a method of manufacturing the wire harness according to the embodiment.

FIG. 11 is a schematic perspective view of a wire harness according to a modification.

FIG. 12 is a schematic cross-sectional view of a wire harness according to a modification.

FIG. 13 is a schematic cross-sectional view depicting a method of manufacturing a wire harness according to a modification.

FIG. 14 is a schematic cross-sectional view depicting a method of manufacturing a wire harness according to a modification.

FIG. 15 is a schematic cross-sectional view depicting a wire harness according to a modification.

FIG. 16 is a schematic side view depicting a wire harness according to a modification.

### DETAILED DESCRIPTION OF EMBODIMENTS

### Outline of Embodiments of the Present Disclosure

Several embodiments of the present disclosure will first be listed and described in outline.

(1) A tubular member according to the present disclosure is a tubular member which is made of resin and through which an electric wire is passed, the tubular member including: a bellows portion that is tubular and includes a bellows structure in which a first peak and a first valley are disposed side by side along an axial direction of the tubular member; and a rigid portion that is tubular and has higher bending rigidity than the bellows portion, wherein the rigid portion includes a second peak and a second valley, which are disposed side by side along the axial direction of the tubular member, a channel portion formed by the second peak and the second valley, and a reinforcing portion formed so as to bury the channel portion at one part in a circumferential direction of the rigid portion, and the reinforcing portion protrudes outward in a radial direction of the tubular member beyond an outer circumferential surface of the second peak and extends along an axial direction of the tubular member.

According to this configuration, a reinforcing portion, which buries the channel portion formed by the second peak and the second valley, is provided at one position in the circumferential direction of the bellows portion. Since part of the channel portion is buried by this reinforcing portion, the bending rigidity of the rigid portion can be increased compared to a configuration where the channel portion is not buried. As one example, since the amount by which the rigid portion can lengthen and contract in the axial direction is smaller when the reinforcing portion buries a portion of the channel portion compared to when the channel portion is not buried, the rigid portion is made more resistant to bending. By doing so, the bending rigidity of the rigid portion is made higher than the bending rigidity of the bellows portion. This means that when an electric wire is passed through the tubular member, the routing of the electric wire can be appropriately favorably maintained by the rigid portion. Also, by adjusting the position of the reinforcing portion in the circumferential direction of the rigid portion, the direction in which the bending rigidity of the rigid portion is increased can be adjusted. In other words, by adjusting the position of the reinforcing portion in the circumferential direction of the rigid portion, it is possible to adjust the direction in which the rigid portion is made resistant to bending. In addition, the reinforcing portion can be formed by crushing part of the first peak in the bellows portion, for example. This means that by changing the position where the first peak is crushed, for example, it is possible to easily change the position of the reinforcing portion. As one example, by changing the position of the reinforcing portion in the axial direction of the tubular member, the position of the rigid portion in the axial direction of the tubular member can be easily changed. As another example, by changing the position of the reinforcing portion in the circumferential direction of the tubular member, the direction in which the bending rigidity of the rigid portion is increased can be easily changed. As a result, it is possible to easily accommodate changes in the specification of a wire harness, which makes wire harnesses easier to manufacture.

The expression “tubular” in the present specification refers to a shape where a peripheral wall is formed around an entire circumference. “Tubular” in the present specification refers to any freely chosen closed shape whose outer edge is connected by straight lines or curves, including a circular tube whose outer edge is circular, a tube whose outer edge is elliptical or oval, a polygonal tube whose outer edge is polygonal, and a tube whose outer edge is in the form of a polygon with rounded corners. The term “tubular” in the present specification simply means that the entire shape can be regarded as being tube-like and also includes shapes where protrusions and recesses or the like are formed on part of an outer periphery and/or part of an inner periphery.

(2) The external shape of the second peak is preferably formed smaller than an external shape of the first peak, and an external shape of the second valley is preferably formed smaller than an external shape of the first valley.

According to this configuration, the reinforcing portion, which protrudes outward in the radial direction of the tubular member, is formed at one part in the circumferential direction of the second valley whose external shape is smaller than the first valley. This means that compared to a configuration where the reinforcing portion is formed at one part in the circumferential direction of the first valley, an increase in the external dimensions of the rigid portion can be suppressed.

(3) The reinforcing portion is preferably formed in a plate shape with a thickness in the circumferential direction of the rigid portion, and the reinforcing portion preferably protrudes outward in a radial direction of the tubular member beyond an outer circumferential surface of the first peak.

According to this configuration, the reinforcing portion is formed in a plate shape with a thickness in the circumferential direction of the rigid portion. This means that at one position in the circumferential direction of the rigid portion, the reinforcing portion is formed to protrude in a rib shape from the bottom of the second valley. This reinforcing portion can favorably increase the bending rigidity of the rigid portion.

(4) An inner circumferential surface of a bottom of the second valley is preferably provided further inward in a radial direction of the tubular member than an inner circumferential surface of a bottom of the first valley.

With this configuration, the internal space at the second valley is smaller than the internal space at the first valley. This means that the rigid portion is formed with a part where the internal space of the tubular member is narrower than at the bellows portion. Accordingly, when an electric wire is passed through the inside of the tubular member, rattling of the electric wire in the internal space of the rigid portion can be favorably prevented.

(5) The rigid portion preferably includes a plurality of the reinforcing portions, and the plurality of reinforcing portions are preferably spaced apart from one another in a circumferential direction of the rigid portion.

According to this configuration, the plurality of reinforcing portions provided at intervals in the circumferential direction of the rigid portion can set a plurality of directions in which the bending rigidity is increased at the rigid portion. In other words, by using a plurality of reinforcing portions provided at freely chosen positions in the circumferential direction of the rigid portion, it is possible to make the rigid portion resistant to bending in a plurality of directions.

(6) The plurality of reinforcing portions are preferably provided at intervals of an equal angle in the circumferential direction of the rigid portion.

According to this configuration, the plurality of reinforcing portions provided at intervals of an equal angle in the circumferential direction of the rigid portion make the rigid portion resistant to bending in a plurality of directions.

(7) The plurality of reinforcing portions are preferably provided at 180-degree intervals in the circumferential direction of the rigid portion.

According to this configuration, the two reinforcing portions provided at 180-degree intervals in the circumferential direction of the rigid portion make the rigid portion resistant to bending in two directions.

(8) The plurality of reinforcing portions are preferably provided at 90-degree intervals in the circumferential direction of the rigid portion.

According to this configuration, the four reinforcing portions provided at 90-degree intervals in the circumferential direction of the rigid portion make the rigid portion resistant to bending in four directions.

(9) The tubular member preferably includes a plurality of the rigid portions, and the plurality of rigid portions are preferably provided along the axial direction of the tubular member.

According to this configuration, a plurality of rigid portions whose bending rigidity is higher than the bellows portion are provided. This plurality of rigid portions can favorably maintain the shape of the tubular member. When an electric wire is passed through the inside of the tubular member, the plurality of rigid portions can favorably maintain the routing of the electric wire.

(10) The plurality of rigid portions preferably include a first rigid portion and a second rigid portion, the reinforcing portion of the first rigid portion is preferably provided at a first position in a circumferential direction of the tubular member, and the reinforcing portion of the second rigid portion is preferably provided at a second position, which differs from the first position, in the circumferential direction of the tubular member.

According to this configuration, the reinforcing portions are provided at different positions in the circumferential direction of the tubular member in the first rigid portion and the second rigid portion. This means that the direction in which the bending rigidity is increased at the first rigid portion and the direction in which the bending rigidity is increased at the second rigid portion can be set at respectively different directions.

(11) The plurality of rigid portions preferably include a first rigid portion and a third rigid portion that are spaced apart in the axial direction of the tubular member, wherein the reinforcing portion of the first rigid portion is preferably provided at a first position in a circumferential direction of the tubular member, and the reinforcing portion of the third rigid portion is preferably provided at the first position in the circumferential direction of the tubular member.

According to this configuration, the reinforcing portions are provided at the same positions in the circumferential direction of the tubular member in the first rigid portion and the third rigid portion. This means that the direction in which the bending rigidity is increased in the first rigid portion and the direction in which the bending rigidity is increased in the third rigid portion can be set at the same direction.

(12) A wire harness according to an aspect of the present disclosure includes the tubular member described above and the electric wire that is passed through the tubular member.

According to this configuration, it is possible to achieve the same effects as the tubular member described above.

### Detailed Description of Embodiments of the Present Disclosure

Specific embodiments of a tubular member and a wire harness according to the present disclosure will now be described with reference to the accompanying drawings. In the drawings, parts of the structures may be depicted larger than actual size or may be simplified for ease of explanation. The ratios between the dimensions of parts may also differ between the drawings. The expressions “perpendicular,” “parallel,” and “entire length” in the present specification do not simply mean strictly perpendicular, parallel, or the entire length, but also include substantially perpendicular, substantially parallel, and substantially the entire length within a range where the effects of the present embodiment are achieved. In some of the accompanying drawings, an X-axis, a Y-axis, and a Z-axis are depicted as perpendicular to each other. In the following description, for ease of explanation, directions that extend along the X-axis are referred to as the “X-axis direction”, directions that extend along the Y-axis are referred to as the “Y-axis direction”, and directions that extend along the Z-axis are referred to as the “Z-axis direction”. Note that the present disclosure is not limited to the embodiments described here, is indicated by the range of the patent claims, and is intended to include all changes and modifications within the meaning and scope of the patent claims and their equivalents.

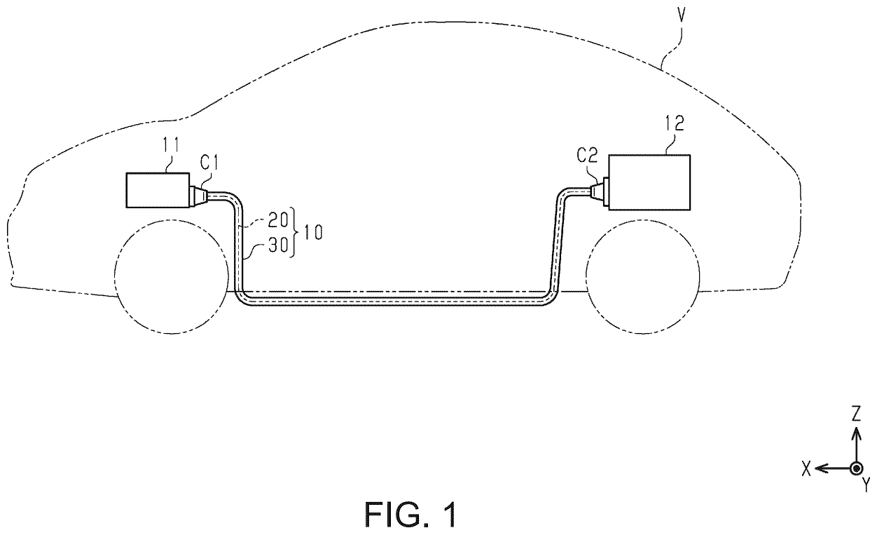

The wire harness 10 depicted in FIG. 1 is mounted in a vehicle V, which for example is a hybrid vehicle or an electric vehicle. The wire harness 10 electrically connects two or more vehicle-mounted devices to each other. These vehicle-mounted devices are electric devices installed in the vehicle V. As one example, the wire harness 10 electrically connects an inverter 11, which is installed at the front of the vehicle V, and a high-voltage battery 12, which is installed in the vehicle V at a position to the rear of the inverter 11. As one example, the wire harness 10 is formed in an elongated shape so as to extend in a front-rear direction of the vehicle V. In one example configuration, the wire harness 10 is routed in the vehicle V so that an intermediate part of the wire harness 10 in the length direction passes an outside of the vehicle interior of the vehicle V, such as under the floor of the vehicle V.

As one example, the inverter 11 is connected to wheel driving motors (not illustrated) that provide the motive force for driving the vehicle. The inverter 11 generates AC power from the DC power of the high-voltage battery 12 and supplies the AC power to the motor. The high-voltage battery 12 is a battery capable of supplying a voltage of several hundred volts, for example.

The wire harness 10 includes an electric wire member 20. As one example, the wire harness 10 includes a pair of connectors C1 and C2 attached to both ends of this electric wire member 20, and a tubular member 30 that is made of resin and surrounds the outer periphery of the electric wire member 20. One end in the length direction of the electric wire member 20 is connected via the connector C1 to the inverter 11, and the other end in the length direction of the electric wire member 20 is connected via the connector C2 to the high-voltage battery 12.

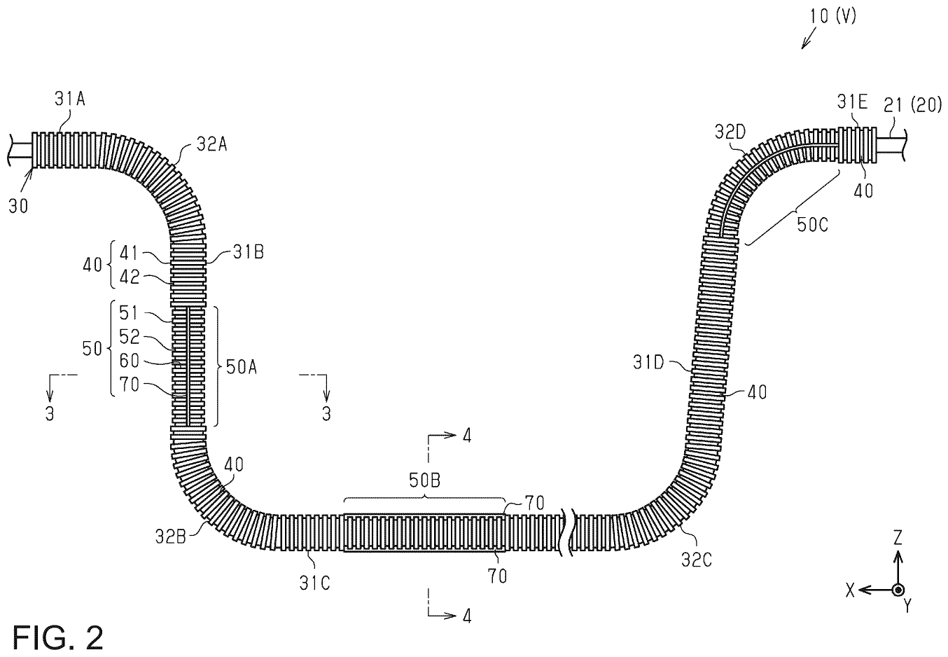

As depicted in FIG. 2 to FIG. 4, the tubular member 30 is in the overall shape of a long tube. The electric wire member 20 is housed in an internal space of the tubular member 30. As depicted in FIG. 2, the tubular member 30 houses an intermediate part in the length direction of the electric wire member 20, for example. In other words, the electric wire member 20 passes through the inside of the tubular member 30.

### Construction of Electric Wire Member 20

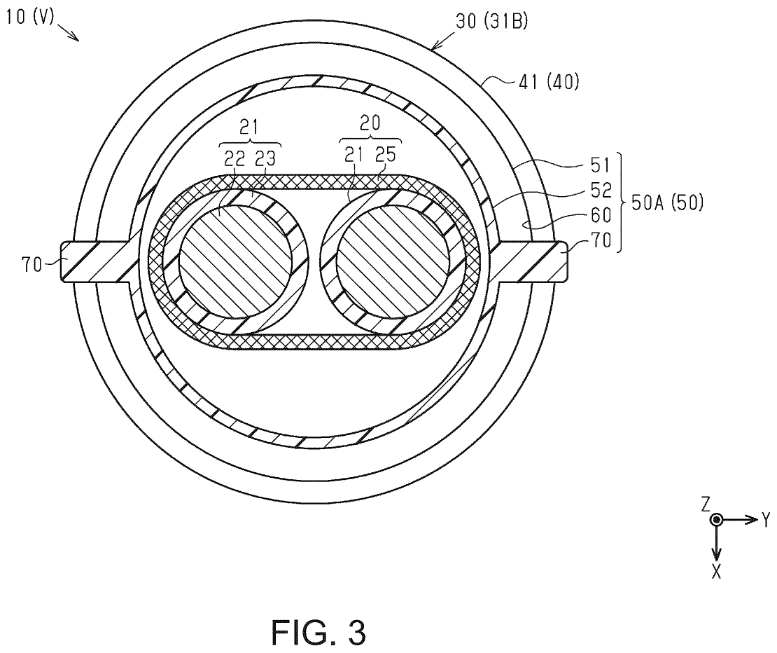

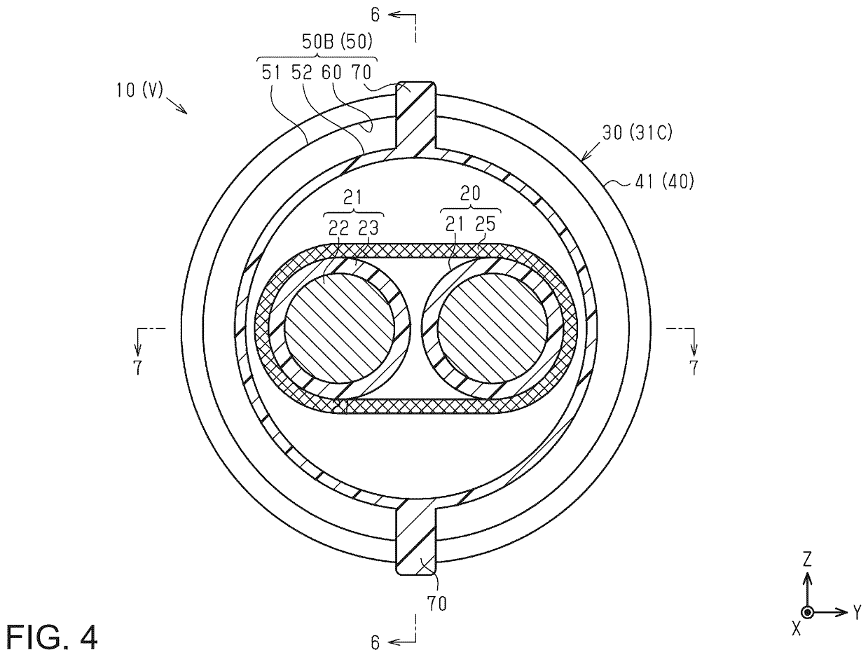

As depicted in FIG. 3 and FIG. 4, the electric wire member 20 includes one or a plurality of electric wires 21, for example. The electric wire member 20 in the present embodiment includes two electric wires 21. In this example, the electric wire member 20 includes a braided member 25 that collectively surrounds the outer periphery of the plurality of electric wires 21.

Each electric wire 21 is a covered electric wire including a core wire 22, which is electrically conductive, and an insulating covering 23, which surrounds the outer periphery of the core wire 22 and is electrically insulating. As one example, each electric wire 21 is a high voltage electric wire that can handle a high voltage and a large current. As examples, each electric wire 21 may be a non-shielded electric wire that does not include an electromagnetically shielding structure, or a shielded electric wire that includes an electromagnetically shielding structure. In the present embodiment, each electric wire 21 is a non-shielded electric wire.

As examples, the core wires 22 may be stranded wires made of a plurality of metal wires that are twisted together or single-core wires made of a single conductor. Such single-core wires may be cylindrical conductors each made of a single cylindrical metal rod with a solid interior, or tubular conductors with a hollow interior, for example. Combinations of a twisted wire, a cylindrical conductor, and/or a tubular conductor may be used as the core wires 22. As examples, the material of the core wires 22 may be a copper-based or aluminum-based metal material.

The insulating covering 23 covers the outer circumferential surface of each core wire 22 around the entire circumference, for example. The insulating covering 23 is composed of a resin material that is electrically insulating, for example.

The cross-sectional shape of each electric wire 21 on a plane that is perpendicular to the length direction of the electric wire 21, that is, the transverse cross-sectional shape of each electric wire 21, may be any shape. As examples, a transverse cross-sectional shape of each electric wire 21 may be a circular, semicircular, polygonal, square, or a flattened shape. In the present embodiment, a transverse cross-sectional shape of each of the electric wires 21 is circular.

As one example, the two electric wires 21 are disposed side by side in the Y-axis direction. In this example, the two electric wires 21 are provided side by side along the Y-axis direction in the internal space of the tubular member 30 and along the entire length of the tubular member 30.

As one example, the braided member 25 has a cylindrical shape that collectively surrounds the outer peripheries of the plurality of electric wires 21. As examples, a braided wire, in which a plurality of metal wires are woven, or a braided wire, in which metal wires and resin wires are woven together, can be used as the braided member 25. A copper-based or aluminum-based metal material can be used as the material of these metal wires, for example. Although not illustrated, both ends in the length direction of the braided member 25 are earthed at the connectors C1 and C2, for example (see FIG. 1). The braided member 25 of this construction functions as an electromagnetically shielding member.

### Construction of Tubular Member 30

The tubular member 30 is tubular in shape and surrounds the outer peripheries of the plurality of electric wires 21 around their entire circumference. The tubular member 30 is also tubular so as to surround the outer periphery of the braided member 25 around its entire circumference. The tubular member 30 in the present embodiment is formed as a circular cylinder. The inner diameter of the tubular member 30 is formed large enough to accommodate the plurality of electric wires 21 and the braided member 25. The tubular member 30 is sealed around the entire circumference of the tubular member 30, for example. The tubular member 30 has a function of protecting the electric wires 21 and the braided member 25 housed inside the tubular member 30 from flying debris and/or water droplets, for example.

As one example, a corrugated tube made of resin can be used as the tubular member 30. As examples, a synthetic resin, such as polyolefin, polyamide, polyester, or ABS resin, can be used as the material of the tubular member 30.

As depicted in FIG. 2, the tubular member 30 may be bent in two or three dimensions for example when mounted on the vehicle V. The tubular member 30 in the present embodiment includes a straight portion 31A that linearly extends along the X-axis direction, a curved portion 32A provided at one end of the straight portion 31A, and a straight portion 31B that extends downward along the Z-axis direction from the curved portion 32A. The tubular member 30 in the present embodiment also includes a curved portion 32B provided at one end of the straight portion 31B, a straight portion 31C that extends rearward along the X-axis direction from the curved portion 32B, and a curved portion 32C provided at one end of the straight portion 31C. The tubular member 30 in the present embodiment further includes a straight portion 31D, which extends upward along the Z-axis direction from the curved portion 32C, a curved portion 32D provided at one end of the straight portion 31D, and a straight portion 31E that extends rearward along the X-axis direction from the curved portion 32D.

The tubular member 30 includes one or a plurality of bellows portions 40 and one or a plurality of rigid portions 50. The tubular member 30 according to the present embodiment includes four bellows portions 40 and three rigid portions 50. The respective bellows portions 40 and rigid portions 50 are formed in tubular shapes. Each bellows portion 40 in the present embodiment is formed as a circular tube. Each rigid portion 50 in the present embodiment is also in the overall form of a circular tube.

The three rigid portions 50 include a rigid portion 50A, a rigid portion 50B, and a rigid portion 50C. In the following description, the rigid portions 50A, 50B, and 50C are collectively referred to as the “rigid portions 50”. As one example, the rigid portion 50A is provided at part of the straight portion 31B. The rigid portion 50B is provided at part of the straight portion 31C, for example. The rigid portion 50C is provided at the curved portion 32D, for example. Each of the rigid portions 50A, 50B, and 50C is provided, for example, at a position that is displaced from the bellows portions 40 in an axial direction where a center axis of the tubular member 30 extends. As one example, the rigid portions 50A, 50B, and 50C are each provided so as to be sandwiched between two bellows portions 40 in the axial direction (that is, the length direction) of the tubular member 30.

The tubular member 30 in the present embodiment is constructed with the four bellows portions 40 and the three rigid portions 50 forming a continuous integral structure. As one example, the four bellows portions 40 and the three rigid portions 50 are integrally formed so as to be continuous with seamless joins. In other words, the tubular member 30 in the present embodiment is an integrally molded product whose entirety, including the four bellows portions 40 and the three rigid portions 50, is made of the same material.

### Construction of Bellow Portions 40

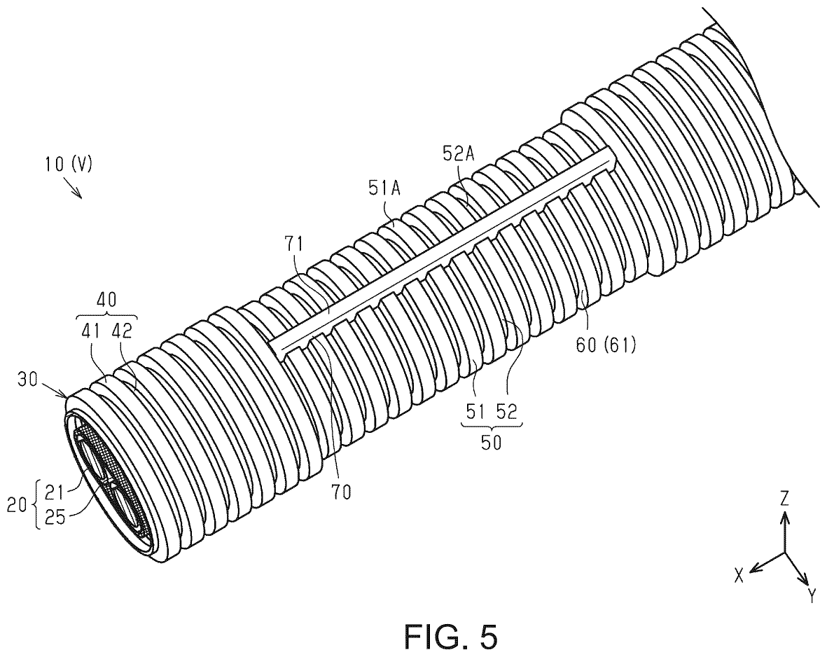

As depicted in FIG. 5, each bellows portion 40 includes a bellows structure in which first peaks 41 and first valleys 42 are provided side by side along the axial direction of the tubular member 30. As one example, each bellows portion 40 includes a plurality of the first peaks 41 and a plurality of the first valleys 42. Each bellows portion 40 is formed, for example, as a bellows structure in which a plurality of first peaks 41 and a plurality of first valleys 42 are alternately provided along the axial direction of the tubular member 30. As one example, each of the first peaks 41 and the first valleys 42 forms a ring-like structure that encircles the tubular member 30 in the circumferential direction. As one example, each of the first peaks 41 and the first valleys 42 in the present embodiment is in the form of a circular ring. Each of the first peaks 41 and the first valleys 42 is formed such that side walls thereof extend continuously and seamlessly around the entire circumference of the tubular member 30. Each of the first peaks 41 and each of the first valleys 42 is formed independently of each other. Each of the plurality of first peaks 41 is formed independently of each other. That is, each first peak 41 is formed individually and is not connected to another first peak 41. Each of the plurality of first valleys 42 is formed independently of each other. That is, each first valley 42 is formed individually and is not connected to another first valley 42.

Here, in this specification, the expression “ring” refers to a ring-like structure whose entirety is connected with no break, that is, an endless structure in which the starting point and the end point match. In addition, in this specification, the term “ring” refers to any closed shape whose outer edge is connected by straight lines or curves, including a circular ring whose outer edge is circular, a ring whose outer edge is elliptical or oval, a ring whose outer edge is polygonal, and a ring whose outer edge is polygonal with rounded corners. The term “ring-shaped” in this specification simply means that the entire structure can be regarded as a ring and also includes structures where protrusions and recesses are formed on part of the outer periphery and/or part of the inner periphery.

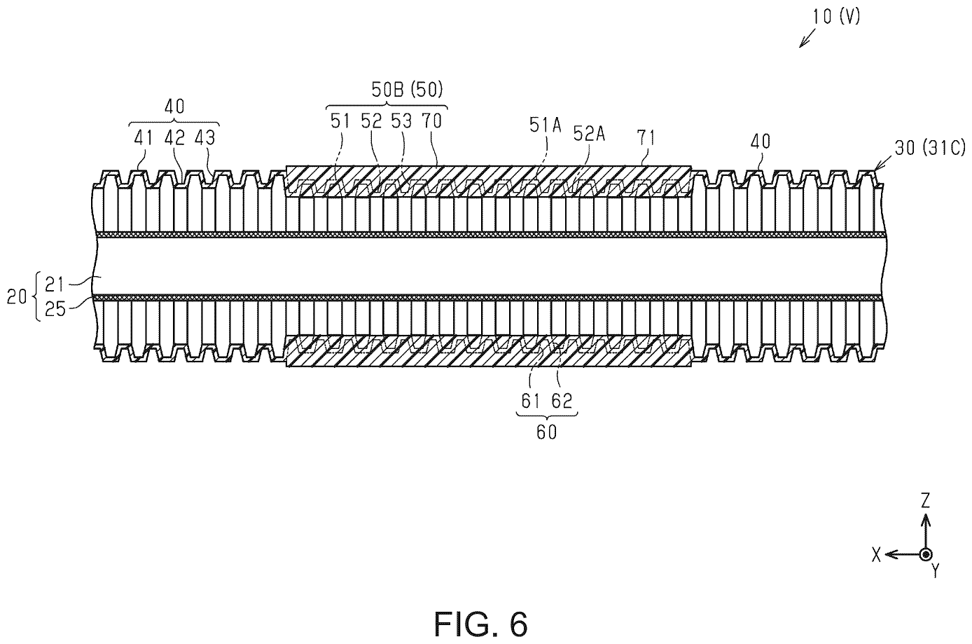

As depicted in FIG. 6, the outer diameter of each first peak 41 is larger than the outer diameter of each first valley 42. The inner diameter of each first peak 41 is larger than the inner diameter of each first valley 42. As one example, each bellows portion 40 is formed with a constant thickness (that is, wall thickness) along the entire length of the bellows portion 40. As one example, the thickness (wall thickness) of the first peaks 41 and the thickness (wall thickness) of the first valleys 42 are equal to each other.

As one example, the bellows portion 40 includes protrusions 43 provided between the tops of the first peaks 41 and the bottoms of the first valleys 42. Each protrusion 43 is formed so as to protrude outward in a radial direction of the tubular member 30 from the bottom of a first valley 42 toward the top of a first peak 41. Each protrusion 43 may extend along the radial direction of the tubular member 30, for example.

### Construction of Rigid Portions 50

Each rigid portion 50 is formed with higher bending rigidity than the bellows portions 40. For example, the rigid portions 50 are more resistant to bending than the bellows portions 40. As one example, the rigid portions 50 are formed with higher bending rigidity than the electric wires 21. The rigid portions 50 are more resistant to bending than the electric wires 21, for example. The rigid portions 50 may be sufficiently rigid to maintain the route of the electric wires 21, for example. As one example, the rigid portions 50 are sufficiently rigid to prevent a state of being straight or a state of being bent from being lost due to vibrations of the vehicle, the weight of the wiring, and the like when the wiring is mounted in the vehicle V. This means that the rigid portions 50 can keep the electric wires 21 on a desired routing path, for example.

As depicted in FIG. 5, each rigid portion 50 includes second peaks 51 and second valleys 52 disposed side by side along the axial direction of the tubular member 30, and a channel portion 60 (channels) formed by the second peaks 51 and the second valleys 52. Each rigid portion 50 includes one or a plurality of reinforcing portions 70 (reinforcements), which are each formed to bury the channel portion 60 at one position in the circumferential direction of the rigid portion 50. Each rigid portion 50 in the present embodiment includes two reinforcing portions 70. Each rigid portion 50 is formed, for example, by machining one part in the axial direction of the bellows portion 40. As one example, at each rigid portion 50, the second peaks 51, the second valleys 52, and the reinforcing portion(s) 70 are formed by crushing parts of the first peaks 41.

Each of the plurality of second peaks 51 is formed in an overall ring shape. Each of the plurality of second peaks 51 forms in an overall ring shape together with the reinforcing portion(s) 70, which are each formed at one position in the circumferential direction of the rigid portion 50. In the present embodiment, each of the second peaks 51 is formed in an overall ring shape together with the reinforcing portion(s) 70. Here, as one example, the reinforcing portion 70 is formed so as to connect two second peaks 51 that are adjacent to each other in the axial direction of the rigid portion 50. This means that the plurality of the second peaks 51 are formed so as to be connected to each other via the reinforcing portions 70. Each of the plurality of second valleys 52 is formed in an overall ring shape. Each of the plurality of second valleys 52 is formed in an overall ring shape together with the reinforcing portion(s) 70, which are each formed at one position in the circumferential direction of the rigid portion 50. In the present embodiment, each second valley 52 is formed in an overall ring shape together with the reinforcing portion(s) 70. In this example configuration, each reinforcing portion 70 is formed so as to connect two second valleys 52 that are adjacent in the axial direction of a rigid portion 50. This means that the plurality of second valleys 52 are formed so as to be connected to each other via the reinforcing portions 70.

### Construction of Second Peaks 51 and Second Valleys 52

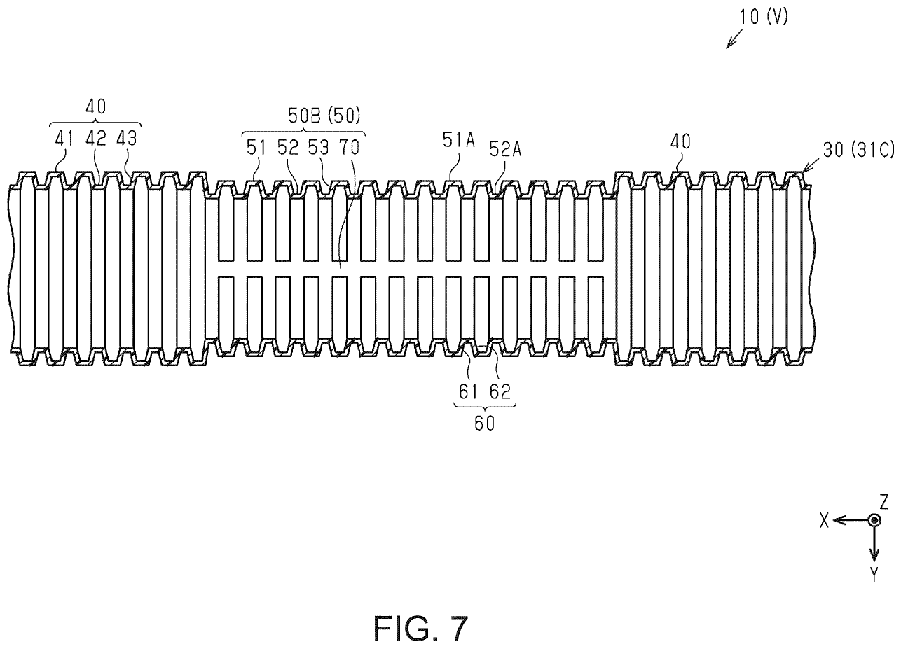

As depicted in FIG. 7, each second peak 51 protrudes radially outward from the tubular member 30 further than the bottoms of the second valleys 52. Each second valley 52 is recessed inward in the radial direction of the tubular member 30 from the tops of the second peaks 51. The external shape of each second peak 51 is larger than the external shape of each second valley 52. The inner circumferential surfaces of the bottoms of the second valleys 52 are provided inward in the radial direction from the inner circumferential surfaces of the tops of the second peaks 51. As one example, the thickness (that is, wall thickness) of the second peaks 51 is equal to the thickness (that is, wall thickness) of the second valleys 52. In each rigid portion 50, the thickness of the second peaks 51 and the thickness of the second valleys 52 are formed so as to be constant over the entire length of the rigid portion 50, for example. The thickness of the second peaks 51 is equal to the thickness of the first peaks 41 and the thickness of the first valleys 42, for example. The thickness of the second valleys 52 is equal to the thickness of the first peaks 41 and the thickness of the first valleys 42, for example.

The cross-sectional shape of the top of each second peak 51 and the cross-sectional shape of the bottom of each second valley 52 may be any freely chosen shapes. As one example, the cross-sectional shape of the top of each second peak 51 and the cross-sectional shape of the bottom of each second valley 52 may be tapered in needle-like shapes or may be curved surfaces that are curved in an arc. In the present embodiment, the top of each second peak 51 has a plateau portion 51A. In the present embodiment also, the bottom of each second valley 52 has a valley floor portion 52A. The plateau portions 51A and the valley floor portions 52A are formed so as to extend as flat surfaces in both the axial and circumferential directions of the tubular member 30, for example. As one example, the plateau portions 51A and the valley floor portions 52A are formed so as to extend parallel to the axial direction of the tubular member 30. The plateau portions 51A and the valley floor portions 52A may be formed so as to extend parallel to the circumferential direction of the tubular member 30, for example. The valley floor portions 52A may be formed so as to extend in parallel to the plateau portions 51A, for example.

### Construction of Second Peaks 51

As depicted in FIG. 3 and FIG. 4, the external shape of each second peak 51 is smaller than the external shape of each first peak 41. As one example, the outer diameter of each second peak 51 aside from at the reinforcing portion(s) 70 is smaller than the outer diameter of each first peak 41. As depicted in FIG. 6, as one example, the outer circumferential surface of the top of each second peak 51, that is, the outer circumferential surface of the plateau portion 51A, is provided inward in the radial direction of the tubular member 30 of the outer circumferential surfaces of the tops of the first peaks 41. As one example, the outer circumferential surfaces of the plateau portions 51A are provided inward in the radial direction of the tubular member 30 than the inner circumferential surfaces of the tops of the first peaks 41. As one example, the outer circumferential surfaces of the plateau portions 51A are provided outward in the radial direction of the tubular member 30 than the outer circumferential surfaces of the bottoms of the first valleys 42. As one example, the inner diameter of each second peak 51 aside from at the reinforcing portion(s) 70 is smaller than the inner diameter of each first peak 41. As one example, the inner circumferential surface of the top of each second peak 51, i.e., the inner circumferential surface of the plateau portion 51A, is provided inward in the radial direction of the tubular member 30 than the inner circumferential surface of the top of each first peak 41. As one example, the inner circumferential surfaces of the plateau portions 51A are provided inward in the radial direction of the tubular member 30 than the outer circumferential surfaces of the bottoms of the first valleys 42. As one example, the inner circumferential surfaces of the plateau portions 51A are provided outward in the radial direction of the tubular member 30 than the inner circumferential surfaces of the bottoms of each first valleys 42. In other words, each second peak 51 is formed so that the internal space of the tubular member 30 is smaller than at each first peak 41.

### Construction of Second Valleys 52

As one example, the external form of each second valley 52 is smaller than the external form of each first valley 42. The outer diameter of each second valley 52 aside from at the reinforcing portion(s) 70 is smaller than the outer diameter of each first valley 42, for example. As one example, the outer circumferential surface of the bottom of each second valley 52, that is, the outer circumferential surface of the valley floor portion 52A is provided inward in the radial direction of the tubular member 30 than the outer circumferential surface of the bottom of each first valley 42. The outer circumferential surface of each valley floor portion 52A is provided inward in the radial direction of the tubular member 30 than the inner circumferential surface of the bottom of each first valley 42, for example. As one example, the inner diameter of each second valley 52 aside from at the reinforcing portion(s) 70 is smaller than the inner diameter of each first valley 42. As one example, the inner circumferential surface of the bottom of each second valley 52, that is, the inner circumferential surface of the valley floor portion 52A, is provided inward in the radial direction of the tubular member 30 than the inner circumferential surface of the bottom of each first valley 42, for example. In other words, each second valley 52 is formed so that the internal space of the tubular member 30 is smaller than at each first valley 42.

As one example, each rigid portion 50 includes a protrusion 53 provided between each plateau portion 51A and each valley floor portion 52A. Each protrusion 53 is formed so as to protrude outward in the radial direction of the tubular member 30 from a valley floor portion 52A toward a plateau portion 51A, for example. Each protrusion 53 extends, for example, along the radial direction of the tubular member 30. Each protrusion 53 is formed so as to extend on a plane that intersects the valley floor portions 52A and the plateau portions 51A, for example. As one example, the distance by which each protrusion 53 extends in the radial direction is equal to the distance by which each protrusion 43 extends in the radial direction or is shorter than the length by which the protrusion 43 extends in the radial direction.

### Construction of Channel Portions 60

As one example, each channel portion 60 includes a first channel portion 61 provided on the outer circumferential side of the tubular member 30 and a second channel portion 62 provided on the inner circumferential side of the tubular member 30. The rigid portion 50 includes a plurality of the first channel portions 61 and a plurality of the second channel portions 62, for example.

Each first channel portion 61 is formed between a second peak 51 and a second valley 52 on the outer circumference of the tubular member 30. Each first channel portion 61 is provided between two of the second peaks 51 that are adjacent in the axial direction of the tubular member 30. As one example, each first channel portion 61 is formed by an outer circumferential surface of a valley floor portion 52A and outer surfaces of two protrusions 53 that extend from both ends of the valley floor portion 52A. Each first channel portion 61 extends, for example, on the outer circumference of the rigid portion 50 around the circumferential direction of the rigid portion 50. The plurality of first channel portions 61 are provided at intervals along the axial direction of the tubular member 30. The plurality of first channel portions 61 are formed independently of one another.

Each second channel portion 62 is formed between a second peak 51 and a second valley 52 on the inner circumference of the tubular member 30. Each second channel portion 62 is provided between two of the second valleys 52 that are adjacent in the axial direction of the tubular member 30. Each second channel portion 62 is formed, for example, by an inner circumferential surface of a plateau portion 51A and inner surfaces of two protrusions 53 that extend from both ends of the plateau portion 51A. Each second channel portion 62 extends, for example, on the inner circumference of the rigid portion 50 around the circumferential direction of the rigid portion 50. The plurality of second channel portions 62 are provided at intervals along the axial direction of the tubular member 30. The plurality of second channel portions 62 are formed independently of one another.

### Construction of Reinforcing Portions 70

As depicted in FIGS. 5 and 6, each reinforcing portion 70 is provided at only one part in the circumferential direction of a rigid portion 50. Each reinforcing portion 70 is formed, for example, so as to bury the first channel portion 61 at one part in the circumferential direction of the rigid portion 50. As one example, each reinforcing portion 70 is formed so as to split the first channel portion 61 at one position in the circumferential direction of the rigid portion 50. This means that the first channel portions 61 that extend around the circumference of the rigid portion 50 are split by the reinforcing portion(s) 70. As depicted in FIG. 6, as one example, each reinforcing portion 70 is formed so as to fill the first channel portion 61 at one position in the circumferential direction of the rigid portion 50. The respective reinforcing portions 70 are formed continuously and integrally with the outer circumferential surfaces of the valley floor portions 52A, for example. Each reinforcing portion 70 is also formed continuously and integrally with the outer circumferential surfaces of the plateau portions 51A, for example. Each reinforcing portion 70 is formed continuously and integrally with the outer surfaces of the protrusions 53, for example. As one example, each reinforcing portion 70 is formed so as to protrude outward in the radial direction of the tubular member 30 from the outer circumferential surfaces of the valley floor portions 52A. As one example, each reinforcing portion 70 is formed so as to protrude outward in the radial direction of the tubular member 30 beyond the outer circumferential surfaces of the second peaks 51. Each reinforcing portion 70 may be formed so as to also protrude outward in the radial direction of the tubular member 30 beyond the outer circumferential surfaces of the first peaks 41, for example.

Note that for ease of understanding the second peaks 51 and the second valleys 52, the second peaks 51 and the second valleys 52 have been depicted in FIG. 6 using a chain double-dashed line. However, in reality, the interface between a reinforcing portion 70 and the second peaks 51 and the second valleys 52 may disappear, leaving no clear boundary between them.

Each reinforcing portion 70 may be formed so as to bury the second channel portions 62 at one position in the circumferential direction of the rigid portion 50, for example. As one example, each reinforcing portion 70 may be formed so as to fill the second channel portions 62 at one part in the circumferential direction of the rigid portion 50. As one example, each reinforcing portion 70 may be formed so as to split the second channel portions 62 at one position in the circumferential direction of the rigid portion 50. This means that the second channel portions 62 that extend around the circumference of the rigid portion 50 are split by the reinforcing portion(s) 70. As one example, each reinforcing portion 70 may be formed continuously and integrally with the inner circumferential surfaces of the plateau portions 51A. Each reinforcing portion 70 may be formed continuously and integrally with the inner surfaces of the protrusions 53, for example. Each reinforcing portion 70 may be formed continuously and integrally with the valley floor portions 52A, for example. As one example, the inner circumferential surface of each reinforcing portion 70 may be formed on the same plane as the inner circumferential surfaces of the valley floor portions 52A in the radial direction of the rigid portion 50. The inner circumferential surface of each reinforcing portion 70 is formed flush with the inner circumferential surfaces of the valley floor portions 52A, for example.

As depicted in FIG. 5, each reinforcing portion 70 is formed in a plate-like shape. As one example, each reinforcing portion 70 is formed in a plate-like shape that protrudes outward in the radial direction of the tubular member 30 from the inner circumferential surface of the valley floor portions 52A. Each reinforcing portion 70 may have a predetermined thickness in the circumferential direction of the rigid portion 50, for example. As one example, each reinforcing portion 70 extends along the axial direction of the tubular member 30. The respective reinforcing portions 70 may extend linearly along the axial direction of the rigid portion 50, for example. Each reinforcing portion 70 may extend along the entire length in the axial direction of the rigid portion 50, for example. Each reinforcing portion 70 may be formed so as to connect a plurality of second peaks 51 disposed side by side along the axial direction of the rigid portion 50, for example. In other words, at each part in the circumferential direction of the rigid portion 50 where a reinforcing portion 70 is formed, the plurality of second peaks 51 are integrally formed via the reinforcing portion 70. Each reinforcing portion 70 may be formed so as to connect a plurality of second valleys 52 disposed side by side along the axial direction of the rigid portion 50, for example. In other words, at each part in the circumferential direction of the rigid portion 50 where a reinforcing portion 70 is formed, the plurality of second valleys 52 are integrally formed via the reinforcing portion 70. As one example, each reinforcing portion 70 may be formed so as to bury the plurality of first channel portions 61 that are aligned along the axial direction of the rigid portion 50. As depicted in FIG. 6, each reinforcing portion 70 may be formed so as to bury the plurality of second channel portions 62 that are aligned along the axial direction of the rigid portion 50. In this way, at each part in the circumferential direction of the rigid portion 50 where a reinforcing portion 70 is formed, since the reinforcing portion 70, the plurality of second peaks 51, and the plurality of second valleys 52 are continuously and integrally formed, the plurality of first channel portions 61 and the plurality of second channel portions 62 disappear.

As depicted in FIG. 5, each reinforcing portion 70 includes a protruding end surface 71. The protruding end surface 71 may be an end surface that is located outermost in the radial direction of each reinforcing portion 70, for example. The protruding end surface 71 extends along the axial direction of the rigid portion 50. The protruding end surface 71 extends like a belt, for example, along the axial direction of the rigid portion 50. The protruding end surface 71 in the present embodiment is formed as a flat surface. That is, the protruding end surface 71 in the present embodiment does not have undulations.

As depicted in FIG. 3 and FIG. 4, the plurality of reinforcing portions 70 are provided so as to be spaced apart in the circumferential direction of the rigid portion 50. As one example, the plurality of reinforcing portions 70 may be provided at intervals of equal angles in the circumferential direction of the rigid portion 50. The plurality of reinforcing portions 70 may be provided for example at 180-degree intervals in the circumferential direction of the rigid portion 50. That is, the two reinforcing portions 70 in the present embodiment are provided at equal intervals in the circumferential direction of the rigid portion 50. The two reinforcing portions 70 in the present embodiment are provided at positions spaced apart by II (radians) in the circumferential direction of the rigid portion 50. The two reinforcing portions 70 in the present embodiment protrude from the inner circumferential surface of the second valley 52 in respectively opposite directions.

As depicted in FIG. 2, the positions in the circumferential direction of the tubular member 30 at which the reinforcing portions 70 are formed are set at different positions in the rigid portion 50A and the rigid portion 50B. As depicted in FIG. 2 and FIG. 3, in the rigid portion 50A provided on the straight portion 31B of the tubular member 30, the reinforcing portions 70 are provided at first positions in the circumferential direction of the tubular member 30. In more detail, as depicted in FIG. 3, in the rigid portion 50A, two reinforcing portions 70 are provided so as to be aligned with the Y-axis direction. That is, in the rigid portion 50A of the present embodiment, the two reinforcing portions 70 are provided so as to be aligned along the Y-axis direction, which is the direction in which the electric wires 21 are placed side by side. Also, as depicted in FIG. 2 and FIG. 4, in the rigid portion 50B provided in the straight portion 31C of the tubular member 30, the reinforcing portions 70 are provided at second positions that differ from the first positions in the circumferential direction of the tubular member 30. In more detail, as depicted in FIG. 4, in the rigid portion 50B, two reinforcing portions 70 are provided so as to be aligned with the Z-axis direction. That is, in the rigid portion 50B of the present embodiment, the two reinforcing portions 70 are provided so as to be aligned along the Z-axis direction, which is perpendicular to the direction in which the electric wires 21 are placed side by side. In this way, the positions at which the reinforcing portions 70 are formed in the circumferential direction of the rigid portions 50 are shifted by 90 degrees from each other between the rigid portions 50A and 50B.

As depicted in FIG. 2, in the rigid portion 50A and the rigid portion 50C, the formation positions of the reinforcing portions 70 in the circumferential direction of the rigid portion 50 are set at the same positions. That is, in the rigid portion 50C provided at the curved portion 32D of the tubular member 30, like the rigid portion 50A, the two reinforcing portions 70 are provided so as to be aligned with the Y-axis direction.

### Operation of Tubular Member 30

Next, the operation of the tubular member 30 will be described.

The reinforcing portions 70 that bury the channel portions 60 formed by the second peaks 51 and the second valleys 52 are provided at positions in the circumferential direction of the rigid portions 50. Since the channel portions 60 are buried by these reinforcing portions 70, the bending rigidity of the rigid portions 50 can be increased compared to a configuration where the channel portions 60 are not buried. As one example, when the channel portions 60 are buried by the reinforcing portions 70, the amount by which the rigid portions 50 can lengthen and contract in the axial direction is smaller than for a configuration where the channel portions 60 are not buried, which makes the rigid portions 50 more resistant to bending. Here, by adjusting the positions of the reinforcing portions 70 in the circumferential direction of the rigid portions 50, it is possible to adjust the direction(s) in which the bending rigidity of the rigid portions 50 is increased. That is, by adjusting the positions of the reinforcing portions 70 in the circumferential direction of the rigid portions 50, it is possible to adjust the directions in which the rigid portions 50 can be made resistant to bending.

As one example, as depicted in FIG. 3, at the rigid portion 50A, two reinforcing portions 70 are provided so as to be aligned with the Y-axis direction. At this rigid portion 50A, the direction in which the rigid portion 50A is made resistant to bending is set as the Y-axis direction, or in more detail, two directions along the Y-axis. That is, the rigid portion 50A can favorably suppress curving where the center axis of the rigid portion 50A, which extends along the Z-axis direction, becomes bent in the Y-axis direction. In more detail, in situations where the rigid portion 50A is curved so as to bend the central axis of the rigid portion 50A in the Y-axis direction, the reinforcing portions 70 will become disposed on both the inner and outer sides of the part where such curving occurs. At this time, at the reinforcing portions 70, there is reduced ability to lengthen and contract in the axial direction of the rigid portions 50. This makes it possible to suppress any curving of the rigid portion 50A that would bend the central axis of the rigid portion 50A in the Y-axis direction. Note that when the rigid portion 50A is curved so that the central axis of the rigid portion 50A becomes bent in the X-axis direction, the reinforcing portions 70 will have almost no effect on the ability of the second peaks 51 and the second valleys 52 to lengthen and contract. This means that even when the reinforcing portions 70 are provided, the rigid portion 50A can be favorably curved so that the central axis of the rigid portion 50A bends in the X-axis direction.

As one example, as depicted in FIG. 4, at the rigid portion 50B, two reinforcing portions 70 are provided so as to be aligned with the Z-axis direction. At this rigid portion 50B, the direction in which the rigid portion 50B is made resistant to bending is set as the Z-axis direction, or in more detail, two directions along the Z-axis. That is, the rigid portion 50B can favorably suppress curving where the central axis of the rigid portion 50B, which extends along the X-axis direction, becomes bent in the Z-axis direction. Note that even when the reinforcing portions 70 are provided at the rigid portion 50B, the rigid portion 50B can be favorably curved so that the central axis of the rigid portion 50B is bent in the Y-axis direction.

### Method of Manufacturing Wire Harness 10

Next, a method for manufacturing the wire harness 10 will be described. Here, a method for manufacturing the tubular member 30 will be described in detail.

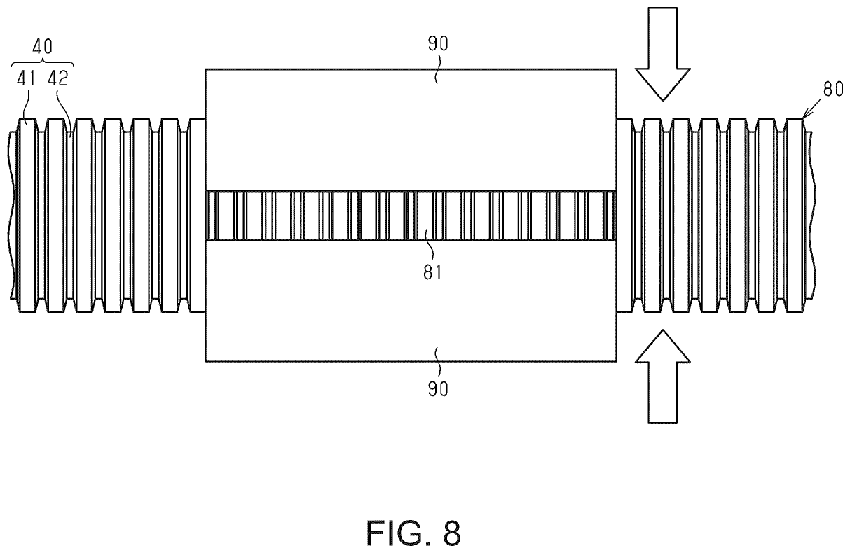

As depicted in FIG. 8, first, a corrugated tube 80 made of a known resin is prepared. In this corrugated tube 80, the bellows portion 40 is formed over the entire length in the axial direction of the corrugated tube 80. The bellows portion 40 is provided with a plurality of first peaks 41 and a plurality of first valleys 42 that are alternately disposed along the axial direction of the corrugated tube 80.

Next, a part of the corrugated tube 80 in the axial direction is processed to form the tubular member 30 depicted in FIG. 2, that is, a tubular member 30 that includes a plurality of rigid portions 50. In more detail, parts of the corrugated tube 80 in the axial direction are processed to crush the first peaks 41. Such processing may be performed using two molds 90, for example. The two molds 90 are provided, for example, at one part in the axial direction of the corrugated tube 80 so as to sandwich the corrugated tube 80 from above and below in the drawing. That is, in the axial direction of the corrugated tube 80, the two molds 90 are disposed at only a first part 81 where a rigid portion 50 is to be formed (see FIG. 2) so that such first part 81 is sandwiched between the two molds 90 from above and below. Each of the two molds 90 extends along the axial direction of the corrugated tube 80.

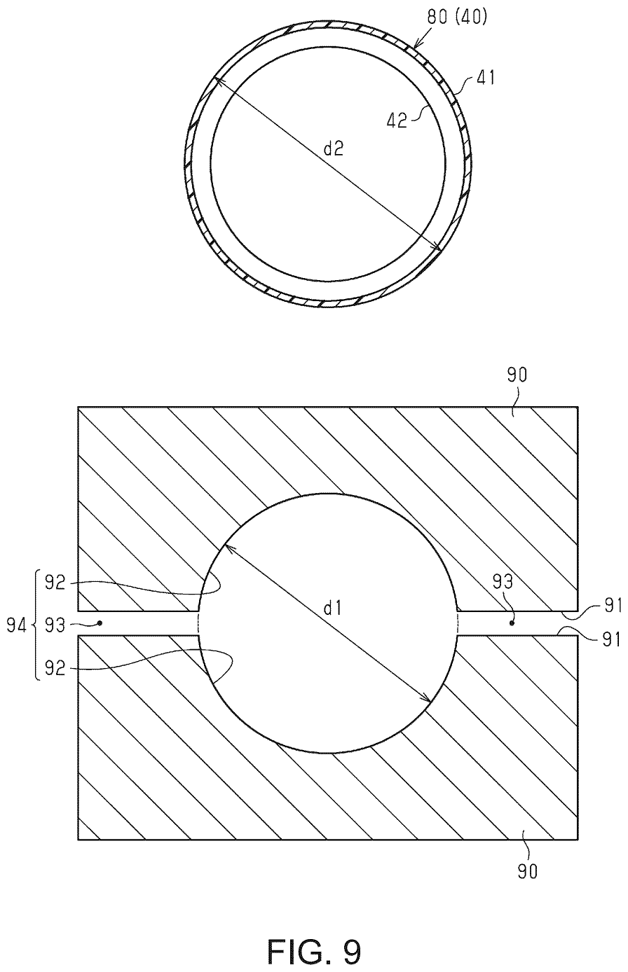

Here, as depicted in FIG. 9, the two molds 90 have facing surfaces 91 that face each other. Each of the two molds 90 has an accommodation channel 92 formed in the facing surface 91. The corrugated tube 80 becomes housed in these accommodation channels 92. In the present embodiment, the cross-sectional shape of the inner surface of each accommodation channel 92 is formed in an arc. The two molds 90 are used in a state where a gap 93 is provided between the facing surfaces 91. In a state where the gap 93 is provided in this way, a housing 94 is formed by the gap 93 and the two accommodation channels 92. This housing 94 is formed so as to be circular in cross section, for example. This housing 94 is formed along the entire length of the molds 90 along the axial direction of the corrugated tube 80. Here, an inner diameter d1 of the housing 94 is set smaller than an outer diameter d2 of the first peaks 41. The inner diameter d1 of the housing 94 is also set larger than the inner diameter of the first valleys 42, for example.

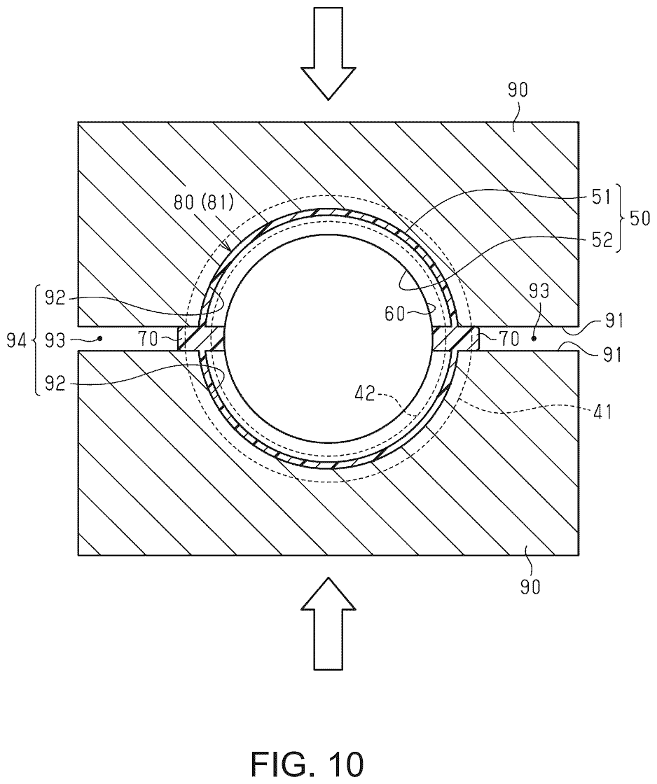

Next, in the process depicted in FIG. 10, the first part 81 of the corrugated tube 80 is heated and softened, and then the first part 81 is sandwiched between two molds 90 and pressed from above and below in the drawing. Through this process, parts of the first peaks 41 in the first part 81 are crushed by the molds 90 so that these crushed parts form the reinforcing portions 70. Note that in FIG. 10, the outer circumferential surface of the first peaks 41 aside from in the first part 81 and the inner circumferential surfaces of the first valleys 42 aside from in the first part 81 are indicated by broken lines. As one example, by surrounding each first part 81 with the two molds 90 that have been heated, the first part 81 is heated and softens. After this, the first part 81 in this heated state is pressed from above and below in the drawing by the two molds 90. At this time, as depicted in FIG. 9, the inner diameter d1 of the housing 94 is smaller than the outer diameter d2 of the first peaks 41. This means that when the first part 81 is pressed by the two molds 90, the outer diameters of the first peaks 41 and the outer diameters of the first valleys 42 are compressed in the first part 81. By doing so, as depicted in FIG. 10, in the first part 81, the second peaks 51 are formed with a smaller outer diameter than the first peaks 41 and the second valleys 52 are formed with a smaller outer diameter than the first valleys 42. In addition, when the first part 81 is pressed by the two molds 90, the first peaks 41 and the first valleys 42 are compressed and at the same time, the first peaks 41 are crushed by the difference between the inner diameter d1 and the outer diameter d2 (see FIG. 9). The crushed first peaks 41 spread to bury the channel portions 60 formed by the second peaks 51 and the second valleys 52 and also spread into the gap 93 between the two molds 90. The first peaks 41 that have spread into the channel portions 60 and the gaps 93 are compressed by pressure applied by the molds 90, and thereby form reinforcing portions 70 at positions in the circumferential direction of the first part 81. These reinforcing portions 70 are formed at the positions in the circumferential direction of the corrugated tube 80 where the gaps 93 are provided. That is, in the present embodiment, the two reinforcing portions 70 are formed in the circumferential direction of the corrugated tube 80. By doing so, the first part 81 that has been heated and pressed by the molds 90 is formed into a rigid portion 50 including two reinforcing portions 70. Here, since this processing is performed by crushing and compressing parts in the circumferential direction of the first peaks 41 within the first part 81 using the molds 90, it is not necessary to insert a core member, which serves as an underlay, inside the corrugated tube 80 when performing this process. This means that compared to a processing method that requires the insertion of a core member, it is possible to simplify the manufacturing process when forming a rigid portion 50.

By carrying out the processing described above on the parts in the axial direction of the corrugated tube 80 where the rigid portions 50 need to be formed, rigid portions 50 can be formed at desired positions in the axial direction of the corrugated tube 80. When doing so, the position and length of a rigid portion 50 can be easily changed by shifting the position of the mold 90 relative to the axial direction of the corrugated tube 80. In addition, the positions of the reinforcing portions 70 in the circumferential direction of the rigid portion 50 can be easily changed by adjusting the positions of the gaps 93 in the molds 90 relative to the circumferential direction of the corrugated tube 80. This means that by processing a single type of corrugated tube 80 using the molds 90, it is possible to manufacture a plurality of types of tubular members 30 where the positions and lengths of the rigid portions 50 and the positions of the reinforcing portions 70 differ. In other words, a plurality of types of tubular member 30 can be manufactured using a single type of the molds 90. Accordingly, even if the layout of the wire harness 10 has changed for example, there is no need to remake the molds for fabricating the tubular member 30 and the change in layout can be handled simply by changing the positions of the molds 90 relative to the corrugated tube 80.

Next, the effects of the present embodiment will be described.

(1) The reinforcing portions 70 are provided at parts in the circumferential direction of each rigid portion 50 so as to bury the channel portions 60 formed by the second peaks 51 and the second valleys 52. Since parts of the channel portions 60 are buried by the reinforcing portions 70, the bending rigidity of each rigid portion 50 can be increased compared to a case where the channel portions 60 are not buried. As one example, since the amount by which a rigid portion 50 can lengthen and contract in the axial direction is smaller when the channel portions 60 are buried by the reinforcing portions 70 compared to when the channel portions 60 are not buried, the rigid portion 50 becomes more resistant to bending. By doing so, the rigid portions 50 are formed with higher bending rigidity than the bellows portion 40. This means that when the electric wires 21 are passed through the tubular member 30, the path of the electric wires 21 can be favorably maintained by the rigid portions 50.

(2) In addition, by adjusting the positions of the reinforcing portions 70 in the circumferential direction of the rigid portions 50, it is possible to adjust the directions in which the bending rigidity of the rigid portions 50 is increased. In other words, by adjusting the positions of the reinforcing portions 70 in the circumferential direction of the rigid portions 50, it is possible to adjust the directions in which a rigid portion 50 is made resistant to bending. Here, the positions of the reinforcing portions 70 in the circumferential direction of the rigid portions 50 are set according to how the wire harness 10 is routed when mounted on the vehicle V, for example. As one example, to suppress bending of a rigid portion 50 in the Y-axis direction for the wire harness 10 when mounted on the vehicle V, the reinforcing portions 70 are provided so as to be aligned along the Y-axis direction in the circumferential direction of the rigid portion 50.

(3) In addition, each reinforcing portion 70 can be formed by crushing part of the first peaks 41 in the bellows portion 40, for example. This means that by changing the position where the first peaks 41 are crushed, for example, the position of a reinforcing portion 70 can be easily changed. Accordingly, by changing the positions of the reinforcing portions 70 in the axial direction of the tubular member 30, the positions of the rigid portions 50 in the axial direction of a tubular member 30 can be easily changed. In addition, by changing the positions of the reinforcing portions 70 in the circumferential direction of the tubular member 30, the direction in which the bending rigidity of a rigid portion 50 is increased can be easily changed. As a result, it is possible to easily accommodate changes in the specification of the wire harness 10, which makes the wire harness 10 easier to manufacture.

(4) The external form of the second peaks 51 is smaller than the external form of the first peaks 41, and the external form of the second valleys 52 is smaller than the external form of the first valleys 42. With this configuration, reinforcing portions 70 that protrude outward in the radial direction of the tubular member 30 are formed at positions in the circumferential direction of the second valleys 52, which have a smaller external form than the first valleys 42. This means that compared to a configuration where the reinforcing portions 70 are formed at parts in the circumferential direction of the first valleys 42, the increase in the external dimensions of the rigid portion 50 can be suppressed.

(5) The reinforcing portions 70 are formed in the shape of plates with a certain thickness in the circumferential direction of the rigid portion 50. This means that at positions in the circumferential direction of the rigid portion 50, the reinforcing portions 70 are formed to protrude in the shape of ribs from the second valleys 52. Such reinforcing portions 70 favorably increase the bending rigidity of the rigid portion 50.

(6) The inner circumferential surfaces of the second valleys 52 are provided inward in the radial direction of the tubular member 30 from the inner circumferential surfaces of the first valleys 42. With this configuration, the internal space inside each second valley 52 is formed smaller than the internal space inside each first valley 42. This means that in each rigid portion 50, a part is formed where the internal space of the tubular member 30 is narrower than the bellows portion 40. Accordingly, rattling of the electric wires 21 inside the internal space of the rigid portion 50 can be favorably suppressed.

(7) Each rigid portion 50 includes a plurality of reinforcing portions 70 that are spaced apart from each other in the circumferential direction of the rigid portion 50. With this configuration, it is possible to set a plurality of directions in which the bending rigidity of the rigid portion 50 is increased by the plurality of reinforcing portions 70. In other words, the plurality of reinforcing portions 70 can make the rigid portion 50 resistant to bending in a plurality of directions.

(8) The plurality of reinforcing portions 70 are provided at 180-degree intervals in the circumferential direction of a rigid portion 50. With this configuration, the two reinforcing portions 70 provided at 180-degree intervals in the circumferential direction of a rigid portion 50 make the rigid portion 50 resistant to bending in two directions. As one example, at the rigid portion 50A of the present embodiment, it is possible to make the rigid portion 50A resistant to bending in the Y-axis direction, or in more detail, in two directions along the Y-axis.

(9) The positions at which the reinforcing portions 70 are formed in the circumferential direction of the tubular member 30 differ between the rigid portions 50A and 50B. This means that the direction in which the bending rigidity is increased at the rigid portion 50A and the direction in which the bending rigidity is increased at the rigid portion 50B can be set at respectively different directions. As one example, although the rigid portion 50A can be made resistant to bending in the Y-axis direction, or in more detail, in two directions along the Y-axis, the rigid portion 50B can be made resistant to bending in the Z-axis direction, or in more detail, in two directions along the Z-axis.

(10) At the rigid portion 50A and the rigid portion 50C, the positions at which the reinforcing portions 70 are formed are set at the same positions in the circumferential direction of the tubular member 30. This means that the direction in which the bending rigidity is increased at the rigid portion 50A and the direction in which the bending rigidity is increased at the rigid portion 50C can be set at the same direction.

### Other Embodiments

The embodiment described above can be modified as follows. The embodiment described above and the following modifications can also be combined with each other within a range that remains technologically consistent.

Although two reinforcing portions 70 are provided in each rigid portion 50 in the embodiment described above, there is no particular limitation on the number of reinforcing portions 70 provided in each rigid portion 50. As one example, the number of reinforcing portions 70 provided in each rigid portion 50 may be one.

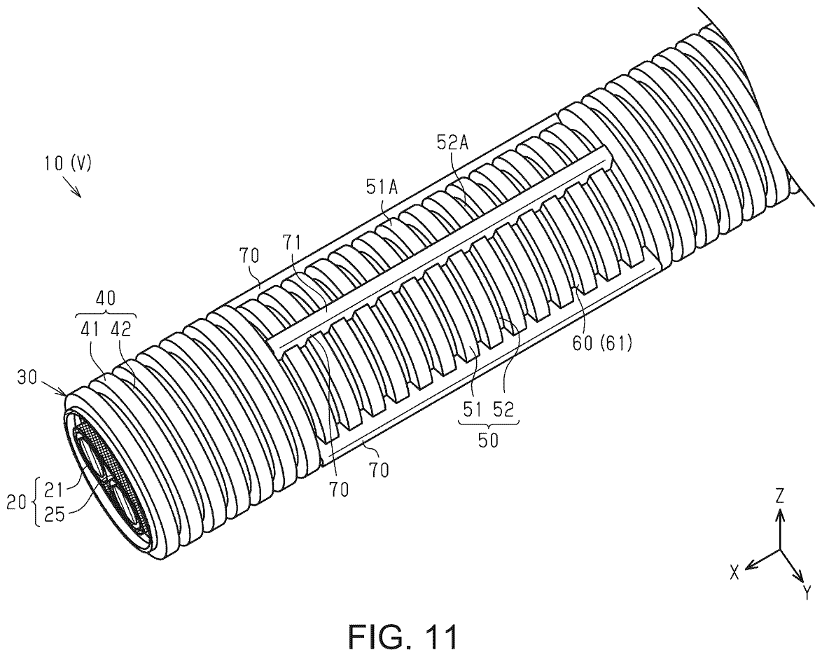

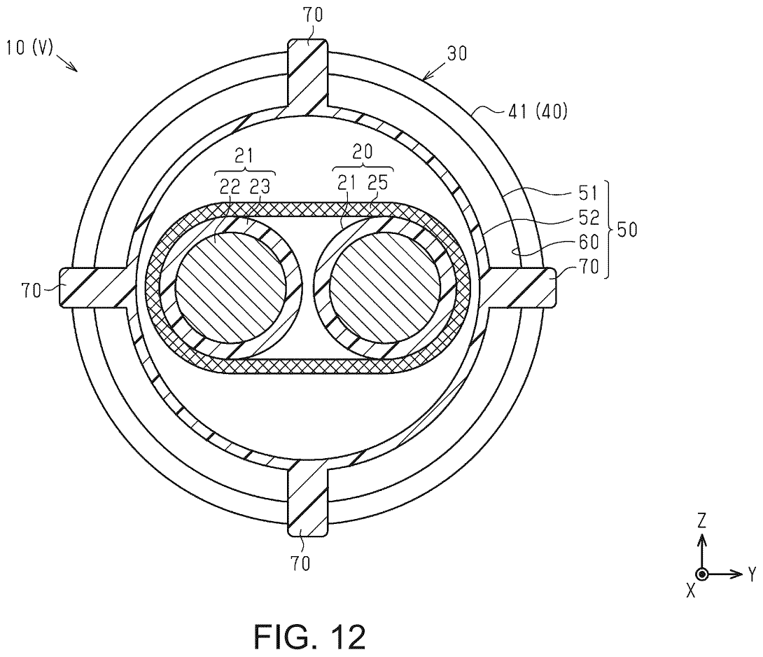

As one example, as depicted in FIG. 11 and FIG. 12, three or more reinforcing portions 70 may be provided at a rigid portion 50. As depicted in FIG. 12, the rigid portion 50 according to this modification includes four reinforcing portions 70. The four reinforcing portions 70 are provided so as to be spaced apart from each other in the circumferential direction of the rigid portion 50. The four reinforcing portions 70 are provided at intervals of an equal angle in the circumferential direction of the rigid portion 50. The four reinforcing portions 70 are provided at 90-degree intervals in the circumferential direction of the rigid portion 50. That is, the four reinforcing portions 70 in this modification are provided at positions that are spaced apart by 11/2 (radians) in the circumferential direction of the rigid portion 50. In this modification, two of the four reinforcing portions 70 are aligned with the Y-axis direction. These two reinforcing portions 70 make the rigid portion 50 resistant to bending in the Y-axis direction, or in more detail, in two directions along the Y-axis. The remaining two of the four reinforcing portions 70 are aligned with the Z-axis direction. These two reinforcing portions 70 make the rigid portion 50 resistant to bending in the Z-axis direction, or in more detail, in two directions along the Z-axis. By doing so, out of the rigid portions 50 in this modification, it is possible to favorably suppress bending of the center axis of the rigid portion 50 that extends along the X-axis direction in the Y-axis direction or the Z-axis direction.

Next, a method of manufacturing the tubular member 30 according to this modification will be described.

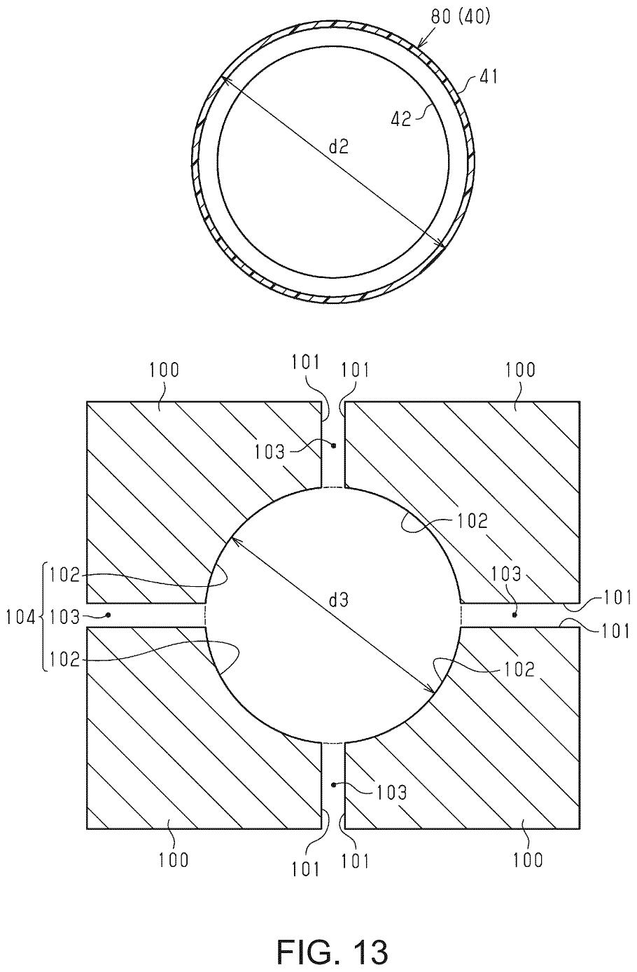

As depicted in FIG. 13, the process of forming the rigid portion 50 (see FIG. 12) by crushing the first peaks 41 at one position in the axial direction of the corrugated tube 80 is performed using four molds 100, for example. That is, molds 100 are used in place of the molds 90 depicted in FIG. 9. Each mold 100 has facing surfaces 101 that face the other molds 100. Each mold 100 has two facing surfaces 101. Each mold 100 also has an accommodation channel 102 formed in the two facing surfaces 101. The corrugated tube 80 is housed inside these accommodation channels 102. The cross-sectional shape of the inner surface of each accommodation channel 102 in this modification is formed in an arc. The four molds 100 are used in a state where gaps 103 are provided between the facing surfaces 101. That is, the four molds 100 are used in a state where the four gaps 103 are provided. In this state where the four gaps 103 are provided, the four gaps 103 and the four accommodation channels 102 form a housing 104. This housing 104 is formed so as to be circular in cross section, for example. The housing 104 is formed across the entire length of the molds 100 along the axial direction of the corrugated tube 80. Here, an inner diameter d3 of the housing 104 is set smaller than the outer diameter d2 of the first peaks 41. The inner diameter d3 of the housing 104 is set larger than the inner diameter of the first valleys 42, for example.

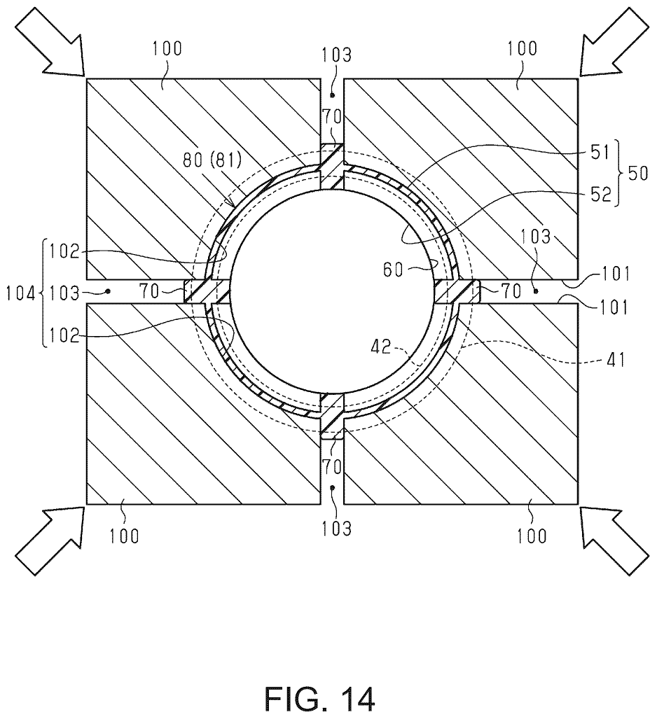

Next, in the process depicted in FIG. 14, the first part 81 of the corrugated tube 80 is heated and softened, and then the first part 81 is sandwiched between the four molds 100 and pressed inward in the radial direction of the corrugated tube 80. In this process, similar to the process shown in FIG. 10, parts of the first peaks 41 in the first part 81 are crushed by the molds 100 so that the crushed parts form the reinforcing portions 70. These reinforcing portions 70 are formed at positions in the circumferential direction of the corrugated tube 80 where the gaps 103 are provided. That is, in this modification, four reinforcing portions 70 are formed in the circumferential direction of the corrugated tube 80. By doing so, the first part 81 that has been heated and pressed by the molds 100 is formed into the rigid portion 50 including the four reinforcing portions 70. Note that in FIG. 14, the outer circumferential surfaces of the first peaks 41 aside from in the first part 81 and the inner circumferential surfaces of the first valleys 42 aside from in the first part 81 are indicated by broken lines.

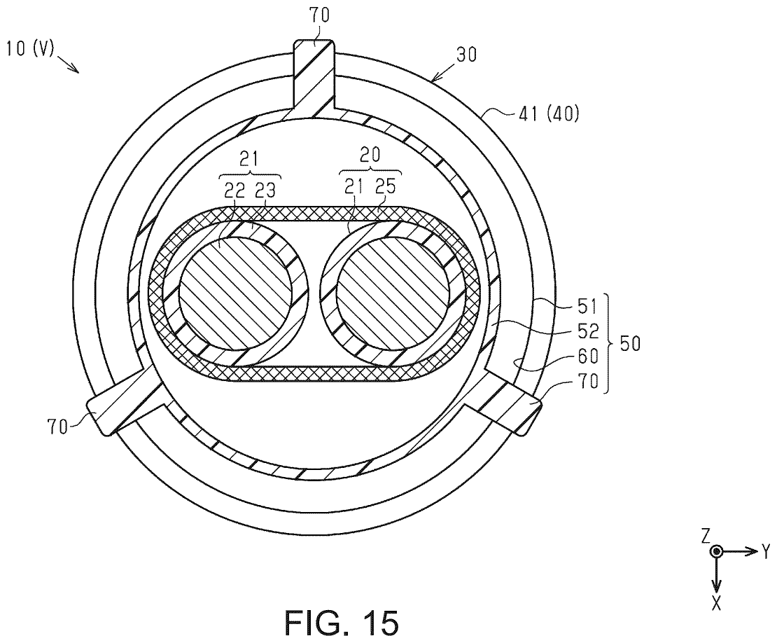

As another example, as depicted in FIG. 15, three reinforcing portions 70 may be provided in a rigid portion 50. These three reinforcing portions 70 are spaced apart in the circumferential direction of the rigid portion 50. The three reinforcing portions 70 are provided at intervals of equal angles in the circumferential direction of the rigid portion 50. The three reinforcing portions 70 are provided at 120-degree intervals in the circumferential direction of the rigid portion 50. That is, the three reinforcing portions 70 in this modification are provided at positions that are spaced apart by 21/3 (radians) in the circumferential direction of the rigid portion 50.

As another example, five or more reinforcing portions 70 may be provided in a rigid portion 50.

A single tubular member 30 may be provided with multiple types of rigid portions 50 including respectively different numbers of reinforcing portions 70. As one example, the number of reinforcing portions 70 in the rigid portion 50A depicted in FIG. 2 may be set at two, the number of reinforcing portions 70 in the rigid portion 50B may be set at four, and the number of reinforcing portions 70 in the rigid portion 50C may be set at one.

Although the plurality of reinforcing portions 70 are provided at intervals of equal angles in the circumferential direction of the rigid portion 50 in the embodiment described above, the present disclosure is not limited to this. As one example, it is sufficient for the plurality of reinforcing portions 70 to be provided at intervals along the circumferential direction of the rigid portion 50, and such intervals are not limited to intervals of equal angles.

Although a plurality of the rigid portions 50 are provided so as to be spaced apart from each other in the axial direction of the tubular member 30 in the embodiment described above, the present disclosure is not limited to this. As one example, a plurality of rigid portions 50 may be provided so as to be adjacent to each other in the axial direction of the tubular member 30.

The number and positions of the rigid portions 50 provided on the tubular member 30 in the embodiment described above can be changed as appropriate. As examples, the number of rigid portions 50 provided on the tubular member 30 may be one or two, or may be four or more. As one example, the rigid portions 50 may be provided at the curved portions 32A, 32B, and 32C. As another example, the rigid portions 50 may be provided at the straight portions 31A, 31D, and 31E.

The length along the axial direction of each rigid portion 50 in the embodiment described above can be changed as appropriate.

Although the protruding end surfaces 71 of the reinforcing portions 70 are formed into flat shapes with no undulations, the present disclosure is not limited to this.

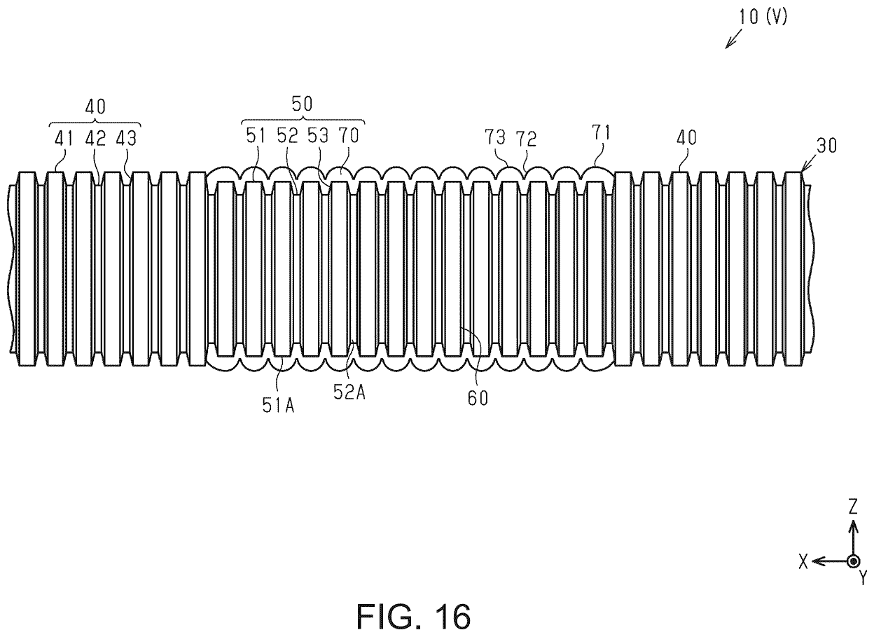

As one example, as depicted in FIG. 16, the protruding end surface 71 of a reinforcing portion 70 may be provided with recesses 72 that are inwardly recessed in the radial direction of the rigid portion 50. The protruding end surface 71 in this modification includes a plurality of recesses 72 provided at intervals along the axial direction of the rigid portion 50. This means that a protrusion 73 is formed between any two recesses 72 aligned along the axial direction of the rigid portion 50. The protruding end surface 71 in this modification has an undulating structure in which a plurality of recesses 72 and a plurality of protrusions 73 are aligned along the axial direction of the rigid portion 50.

As one example, each recess 72 is provided at a position that corresponds to a second valley 52 in the axial direction of the rigid portion 50. The cross-sectional shape of the bottom of each recess 72 may be a freely chosen shape. As examples, the cross-sectional shape of the bottom of each recess 72 may be tapered in a needle-like shape or may be a curved surface that curves in an arc. Each recess 72 in the present modification is tapered in a needle-like shape.

Each protrusion 73 is provided, for example, at a position corresponding to a second peak 51 in the axial direction of the rigid portion 50. The cross-sectional shape of the top of each protrusion 73 may be a freely chosen shape. As examples, the cross-sectional shape of the top of each protrusion 73 may be tapered in a needle-like shape or may be a curved surface that curves in an arc. Each protrusion 73 in the present modification is formed as a curved surface that curves in an arc. Note that as one example, the top of each protrusion 73 is formed so as to protrude outward in the radial direction of the tubular member 30 beyond the outer circumferential surfaces of the first peaks 41.

Although each reinforcing portion 70 is formed to bury both the first channel portions 61 and the second channel portions 62 in the embodiment described above, the present disclosure is not limited to this. As one example, the reinforcing portion 70 may be formed to bury only one of the first channel portions 61 and the second channel portions 62.

Although each reinforcing portion 70 is formed to protrude outward in the radial direction of the tubular member 30 beyond the outer circumferential surfaces of the first peaks 41 in the embodiment described above, the present disclosure is not limited to this. As one example, the protruding end surface 71 of each reinforcing portion 70 may be provided at a position that is recessed inward in the radial direction of the tubular member 30 from the outer circumferential surfaces of the first peaks 41.

Although the thickness of the rigid portion 50 is equal to the thickness of the bellows portion 40 in the embodiment described above, the present disclosure is not limited to this. As one example, the thickness of the rigid portion 50 may be thinner than the thickness of the bellows portion 40.

Although the bellows portion 40 is formed into a bellows structure in which a plurality of first peaks 41 and a plurality of first valleys 42 are alternately disposed along the axial direction of the tubular member 30 in the embodiment described above, the bellows structure is not limited to this. As one example, the bellows portion 40 may be changed to a structure where a single first peak 41 extends in a spiral along the axial direction of the tubular member 30 and one first valley 42 extends in a spiral along the axial direction of the tubular member 30. The bellows portion 40 in this case also has a bellows structure in which the first peak 41 and the first valley 42 are disposed side by side along the axial direction of the tubular member 30. Note that in this case, the rigid portion 50 is also formed so that a second peak 51 extends in a spiral along the axial direction of the tubular member 30 and a second valley 52 extends in a spiral along the axial direction of the tubular member 30.

In the embodiment described above, there is no particular limitation on the number of electric wires 21 included in the wire harness 10, and the number of electric wires 21 can be changed according to the specification of the vehicle V. As examples, the number of electric wires 21 in the wire harness 10 may be one or three or more. As one example, the wire harness 10 may be configured to additionally include low-voltage wires that connect a low-voltage battery and various low-voltage devices (as examples, lamps and car audio).

Although high-voltage wires are described as specific examples of the electric wires 21 in the embodiment described above, the electric wires 21 may be low-voltage wires.

Although the braided member 25 is described as a specific example of an electromagnetic shielding member in the electric wire member 20 according to the present embodiment, the present disclosure is not limited to this. As another example, the electromagnetic shielding member in the electric wire member 20 may be realized by metal foil.

The braided member 25 of the electric wire member 20 in the embodiment described above may be omitted.

The relative positions of the inverter 11 and the high-voltage battery 12 in the vehicle V are not limited to the positions given in the embodiment described above and may be changed as appropriate depending on the vehicle configuration.

Although the inverter 11 and the high voltage battery 12 are used as the vehicle-mounted devices connected by the wire harness 10 in the embodiment described above, the present disclosure is not limited to this. As one example, the wire harness may be used to connect the inverter 11 and a motor for driving the wheels. In other words, the present disclosure is applicable to any harness that electrically connects vehicle-mounted devices installed in a vehicle V.

In the embodiment described above, the rigid portions 50 may be integrally formed of the same material as the bellows portion 40. The reinforcing portions 70 of the rigid portions 50 may be integrally formed of the same material as the second peaks 51 and the second valleys 52 of the rigid portions 50. The rigid portion 50 may have one or a plurality of bellows areas, which extend along the circumferential direction of the rigid portion 50 and have a predetermined length in the circumferential direction, and one or more non-bellows areas (which are the reinforcing portions 70″) aside from the one or a plurality of bellows areas. One or a plurality of bellows areas and one or a plurality of non-bellows areas (the “reinforcing portions 70”) may be provided side by side or alternately in the circumferential direction of the rigid portions 50. Each bellows area of a rigid portion 50 may have second peaks 51 and second valleys 52 disposed side by side along the axial direction of the tubular member 30 so as to be continuous with the bellows portions 40 in the axial direction of the tubular member 30. Each non-bellows area of a rigid portion 50 extends along the axial direction of the tubular member 30 and may be formed in the shape of a plate with a certain thickness in the circumferential direction of the rigid portion 50. Since such non-bellows areas of the rigid portion 50 do not have folds at the boundaries between the second peaks 51 and the second valleys 52 depicted in FIG. 5 for example, such areas are less susceptible to bending/deformation than the bellows area of the rigid portion 50.

The first peaks 41 and the first valleys 42 of the bellows portion 40 may be referred to as “ring-shaped peaks” and “ring-shaped valleys”, respectively. The second peaks 51 and the second valleys 52 of the rigid portions 50 may be referred to as “non-ring-shaped peaks” and “non ring-shaped valleys”, respectively.

In the embodiment described above, in a longitudinal cross-sectional view of the tubular member 30 (see FIG. 6), the protruding end surfaces 71 of the reinforcing portions 70 may extend linearly along the axial direction of the rigid portions 50. The height from the outer circumferential surfaces of the valley floor portions 52A of the second valleys 52 to the protruding end surfaces 71 of the reinforcing portions 70 may be greater than the height from the outer circumferential surfaces of the plateau portions 51A of the second peaks 51 to the protruding end surfaces 71 of the reinforcing portions 70.

In the embodiment described above, as depicted in the longitudinal cross-sectional view of the tubular member 30 (see FIG. 6), the reinforcing portions 70 bridge between two adjacent second peaks 51, and in the longitudinal cross-sectional view (see FIG. 6) of the tubular member 30 at a predetermined position in the circumferential direction of the tubular member 30, the reinforcing portion 70 may completely bury the second valleys 52. In a cross-sectional view of the tubular member 30 at a predetermined position in the circumferential direction of the tubular member 30 (see FIG. 6), the reinforcing portion 70 may completely bury the first channel portions 61 and the second channel portions 62.

In the embodiment described above, the thickness of the reinforcing portion 70 in the circumferential direction of the rigid portion 50 may be greater than the thicknesses of the second peaks 51 and the second valleys 52 in the radial direction of the rigid portion 50

All features of the embodiments disclosed here are exemplary and should not be regarded as limitations on the present disclosure. The scope of the present disclosure is indicated by the range of the patent claims, not the description given above, and is intended to include all changes within the meaning and scope of the patent claims and their equivalents.

1. A tubular member that is made of resin, the tubular member comprising:
a bellows portion that is tubular and includes a bellows structure in which a first peak and a first valley are disposed side by side along an axial direction of the tubular member; and
a rigid portion that is tubular and has a higher bending rigidity than the bellows portion, wherein:
the rigid portion includes a second peak and a second valley, which are disposed side by side along the axial direction of the tubular member, a channel formed by the second peak and the second valley, and a reinforcement formed so as to bury the channel at one part in a circumferential direction of the rigid portion, and
the reinforcement protrudes outward in a radial direction of the tubular member beyond an outer circumferential surface of the second peak and extends along an axial direction of the tubular member.

2. The tubular member according to claim 1, wherein:
an external shape of the second peak is formed smaller than an external shape of the first peak, and
an external shape of the second valley is formed smaller than an external shape of the first valley.

3. The tubular member according to claim 1, wherein:
reinforcement is formed in a plate shape with a thickness in the circumferential direction of the rigid portion, and
the reinforcement protrudes outward in a the radial direction of the tubular member beyond an outer circumferential surface of the first peak.

4. The tubular member according to claim 1,
wherein an inner circumferential surface of a bottom of the second valley is provided further inward in the radial direction of the tubular member than an inner circumferential surface of a bottom of the first valley.

5. The tubular member according to claim 1,
wherein the reinforcement is plurality of reinforcements, and the plurality of reinforcements are spaced apart from one another in the circumferential direction of the rigid portion.

6. The tubular member according to claim 5,
wherein the plurality of reinforcements are provided at intervals of an equal angle in the circumferential direction of the rigid portion.

7. The tubular member according to claim 6,
wherein the plurality of reinforcements are provided at 180-degree intervals in the circumferential direction of the rigid portion.

8. The tubular member according to claim 6,
wherein the plurality of reinforcements are provided at 90-degree intervals in the circumferential direction of the rigid portion.

9. The tubular member according to claim 1, wherein:
the rigid portion is a plurality of rigid portions, and
the plurality of rigid portions are provided along the axial direction of the tubular member.

10. The tubular member according to claim 9, wherein:
the plurality of rigid portions include a first rigid portion and a second rigid portion,
the reinforcement is separately provided in the first rigid portion and the second rigid portion,
the reinforcement of the first rigid portion is provided at a first position in the circumferential direction of the tubular member, and
the reinforcement of the second rigid portion is provided at a second position, which differs from the first position, in the circumferential direction of the tubular member.

11. The tubular member according to claim 9, wherein:
the plurality of rigid portions include a first rigid portion and a third rigid portion that are spaced apart in the axial direction of the tubular member,
the reinforcement is separately provided in the first rigid portion and the third rigid portion,
the reinforcement of the first rigid portion is provided at a first position in the circumferential direction of the tubular member, and
the reinforcement of the third rigid portion is provided at the first position in the circumferential direction of the tubular member.

12. A wire harness comprising:
the tubular member according to claim 1; and
an electric wire that is passed through the tubular member.
